(19) United States
(12) Patent Application Publication
(10) Pub. No.: US 2008/0085647 A1
(43) Pub. Date: Apr. 10, 2008

(54) Insecticide Impregnated Fabric

(76) Inventor: Ulrich Tombuelt, Spartanburg, SC (US)

Correspondence Address: KLARQUIST SPARKMAN, LLP, 121 SW SALMON STREET, SUITE 1600, PORTLAND, OR, 97204, US

(21) Appl. No.: 11/869,587

(22) Filed: Oct. 9, 2007

Related U.S. Application Data
(60) Provisional application No. 60/828,738, filed on Oct. 9, 2006.

(51) Int. Cl. B32B 5/02; B32B 27/04

(52) U.S. Cl. 442/123; 442/59

(57) ABSTRACT

The present disclosure provides fabrics having at least about 80% by fabric weight prior to impregnation of nylon fibers impregnated with an effective amount of an insecticide. In specific examples, the fabric includes 100% by weight nylon 6,6 fibers. In particular implementations, the fabrics are impregnated with an effective amount of permethrin, such as between about 0.30% and about 0.58% permethrin by weight of impregnated fabric. The fabric may be constructed to provide improved tactile properties, such as weight, breathability, and strength. The fabrics retain an effective amount of insecticide after being washed. In particular examples, the fabric is formed into a fly sheet, such as for horses. Also provided are methods of forming such fabrics and methods of treating dermatological conditions using such fabrics.

### CROSS REFERENCE TO RELATED APPLICATIONS

This application claims the benefit of, and incorporates by reference, U.S. Provisional Patent Application No. 60/828,738, filed Oct. 9, 2006.

### FIELD

The present disclosure relates to insecticidal fabrics and their methods of manufacture. Specific embodiments relate to horse fly sheets impregnated with permethrin.

### BACKGROUND

Much effort is spent on repelling or killing insects. Insects can be a nuisance to both humans and animals. In addition, insects may spread disease. Animals, such as horses, can develop rashes and itching in response to the bites of insects such as gnats and flies, such as Culicoides flies. An animal's attempts to scratch the rash can cause skin damage and hair loss, which can resemble mange. These conditions are known by various terms, such as summer eczema and sweet itch.

A wide variety of insect killing and repelling compositions are known. However, it can be desirable to use compositions that are derived from naturally occurring substances or that otherwise have low toxicity to the humans or animals with which the composition will be used. One such class of substances is pyrethrin and pyrethroids derived therefrom. Pyrethrin is a natural insecticide derived from pyrethrum, a flowing plant of the chrysanthemum family. Such compounds typically exhibit strong insecticidal activity but low toxicity to humans and other mammals.

Prior efforts to combat insects often involve applying an insect repellant to a body surface or to an article to be placed on a body surface. One strategy for combating insects has been to impregnate a fabric with an insecticide. The fabric may be formed into such articles as tents, clothing, and horse blankets. The impregnated fabrics often exhibit satisfactory repellant properties, sometimes even after multiple washings. Some fabrics have been impregnated with permethrin or related substances. One example is the Expel Fly Sheet, sold by Royal Riders of Morgan Hill, Calif.

However, prior impregnated fabrics may still suffer from disadvantages that may limit their use. For example, the fabrics on which the insecticide has been applied are typically of unsatisfactory quality, such as lacking desirable tactile qualities. Some such fabrics are too stiff or are uncomfortable to a user. Other fabrics may lack suitable wicking, vapor transport, or thermal characteristics.

### SUMMARY

In particular embodiments, the present disclosure provides fabrics having insecticidal properties, such as being impregnated with an effective amount of an insecticide. An effective amount of insecticide, in some implementations, is retained in the fabric after the fabric is washed. In specific implementations, the fabric is impregnated with permethrin, such as at least about 0.30% permethrin by weight of the impregnated fabric. For example, the fabric may include about 0.52% to about 0.58% permethrin by weight of the impregnated fabric. In further examples, the fabric includes less than about 3% permethrin by weight of the impregnated fabric.

The fabric is constructed from synthetic fibers or a combination or mixture of synthetic and natural fibers. Prior to impregnation, the fabric is made of at least about 80% polyamide fiber, such as nylon, by fabric weight. In a particular example, the fiber is nylon 6,6. The remaining 20% of the fabric fibers may be natural or synthetic fibers, or a mixture thereof. In a more specific example, prior to impregnation, the fabric is made of 100% nylon 6,6 fibers by fabric weight.

In particular implementations, the fabric is constructed for use as a fly sheet, such as for horses. In such implementations, the fabric may be constructed to have suitable tactile properties. In some examples, prior to impregnation, the fabric is constructed with a weight of between about 3.26 oz/yd² and about 4.41 oz/yd², such as about 3.84 oz/yd². Prior to impregnation, the fabric has a thickness of between about 450 μm and about 710 μm, such as about 580 μm. The fabrics, prior to impregnation, have an open surface of between about 14.2% and about 19.2%, such as 16.7%.

In more specific examples, the fabric is constructed using a plain weave and the weft has about 2-3 times as many threads per inch as the warp, such as about 16.7 threads per inch in the weft and about 6.6 threads per inch in the warp. The elongation of such fabrics, prior to impregnation, may be between about 25% and about 40%, such as about 35% in the warp and about 34% in the weft.

Further embodiments provide methods of manufacturing the above-described fabrics. In one implementation, the fabric is woven and heat set. The fabric is then treated with an impregnating solution of insecticide. In some processes, the impregnating solution includes a binder, such as starches, acrylics, or polymeric binders, to help retain an effective amount of the insecticide in the fabric. The impregnating solution, in specific examples, includes other substances to aid in the impregnation process, such as defoamers or wetting agents.

Yet further embodiments of the present disclosure provide methods of repelling or killing insects, including methods of treating conditions caused by such insects, such as sweet itch or summer eczema. One such method includes covering at least a portion of an animal with an above-described fabric. Repelling or killing insects causing sweet itch or summer eczema can reduce or eliminate such conditions.

Compared to prior fabrics, the presently disclosed fabrics can have improved tactile properties, such as improved softness, strength, and breathability. Such improved properties can make the fabrics more comfortable for animals and increase the use of such fabrics to repel or kill insets, thus potentially reducing or eliminating conditions caused by such insects.

There are additional features and advantages of the subject matter described herein that will become apparent as this specification proceeds.

In this regard, it is to be understood that this is a brief summary of several aspects of the subject matter described herein. The various features described in this section and below for various embodiments may be used in combination or separately. Any particular embodiment need not provide all features noted above, nor solve any particular set of problems in the prior art noted above.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together.

Although methods and materials similar or equivalent to those described herein can be used in the practice or testing of the present disclosure, suitable methods and materials are described herein. The disclosed materials, methods, and examples are illustrative only and not intended to be limiting.

The present disclosure generally relates to synthetic fabrics impregnated with an insecticide. The fabrics include at least about 80% polyamide fibers by weight of the fabric prior to impregnation, such as nylon fibers. When the synthetic fabric is nylon, the nylon may be a nylon copolymer having any suitable ratio of diacid and diamine monomer units. For example, the nylon may be nylon 4,6, nylon 6,6, nylon 6,9, nylon 6,10, nylon 6,12, or nylon 5,10. The nylon may also be a nylon homopolymer, such as nylon 6, nylon 9, nylon 11, or nylon 12. In particular examples, such as when the fabric is to be used as a fly sheet, the fabric is made of nylon 6,6 fibers.

The remaining 20% of the fabric may include one or more synthetic fibers, such as polyesters, polyolefins, and acrylonitriles. The remaining 20% may also include one or more natural fibers such as cotton or wool. In particular examples, the fabric is made of 100% nylon 6,6 fibers.

Compared to prior impregnated fabrics, such as polyester materials, the disclosed fabrics can be softer, stronger, lighter, or more breathable. The particular composition of the fabric may be chosen to provide desired fabric characteristics.

The fabric weight can be selected depending on the particular end use of the fabric. Typical fabric weights of the fabric prior to impregnation are between about 1 oz/yd² and about 5 oz/yd² (about 33 g/m² and about 170 g/m²). For example, blankets for animals, such as fly sheets, may have a fabric weight of between about 3.26 oz/yd² and about 4.41 oz/yd² (about g/m² 110.5 and about 149.5 g/m²). In a particular example, the sheet has a weight of about 3.84 oz/yd² (about 130 g/m²).

In addition to the fabric weight, the fabric thickness can be varied to provide desired fabric properties, such as warmth or durability. In some implementations, the fabric is about 200 μm to about 2000 μm thick prior to impregnation, such as having a thickness of about 450 μm to about 710 μm. For example, when the fabric is to be used as a fly sheet, the fabric may be about 580 μm thick.

The fabric can be constructed with mesh sizes that provide a desired amount of breathability or other quality to the fabric. In particular implementations, prior to impregnation, the fabric has an open surface of about 14.2% to about 19.2%. In a specific example, the fabric has an about surface of about 16.7%. The open surface area can be determined from the equation:

Open Area=100*(mesh opening)²/(wire diameter+mesh opening)²

The size of the fabric may be chosen based on a particular end use. For example, when the article to be produced is a fly sheet, the fabric may have a width of about 80 inches.

The fabric may be woven using a desired weave, such as a plain weave, twill weave, cross twill weave, or a satin weave. In a particular example, the weave is a L1/1 plain weave. The warp-to-weft ratio of the fabric may be chosen to provide desired fabric characteristics. In particular implementations, the weft has about 2-3 times as many threads per inch as the warp. For example, when the fabric is to be used as a fly sheet, the warp may have about 6.6 threads per inch and the weft may have about 16.7 threads per inch.

The fabric may be constructed with desired elongation characteristics to provide a desired stretchability. In examples where the fabric is to be used as a fly sheet, the fabric may be constructed with a warp or weft elongation prior to impregnation of about 25% and about 40%. In a particular example, the fabric has a warp elongation of about 35% and a weft elongation of about 34%.

The disclosed fabrics include an effective amount of an insecticide. As used in the present disclosure, an effective amount of an insecticide is an amount sufficient to produce a desired level of insect repelling or killing activity. The amount of insecticide included in the fabric may be varied to achieve a desired level of insecticidal activity, which can be measured by methods known in the art for determining repellant activity, knock-down, or mortality. The amount of insecticide included in the fabric may also be influenced by toxicity concerns or regulatory requirements. In particular embodiments, the insecticide is at least one pyrethroid, such as a synthetic pyrethroid such as permethrin, deltamethrin, allethrin, cypermethrin, cyfluthrin, etofenprox, λ-cyhalothrin, bifenthrin, or a mixture thereof. In particular examples, the fabric includes at least about 0.30% pyrethroid (e.g. permethrin) by weight of impregnated fabric, such as between about 0.38% and 0.58% by weight of impregnated fabric. In more specific examples the fabric includes between about 0.52% and 0.58% pyrethroid (e.g. permethrin) by weight of impregnated fabric. In further implementations, the fabric includes less than about 3% pyrethroid (e.g. permethrin) by weight of impregnated fabric.

In some embodiments, the pyrethroid is retained in the fabric even after washing. For example, the fabric retains an effective amount of insecticidal activity after at least 10 washings, such as at least 25 washings.

The disclosed fabrics may be formed by any suitable process, as is known in the art. The parameters of the manufacturing process may be varied to provide the particular fabric properties discussed above.

In particular implementations, the fabric is heat set after it is woven. Heat setting anneals the molecules of the fabric, drives off moisture, and can result in stronger hydrogen bonding between neighboring molecules. Heat setting may help prevent the yarn from moving or shrinking when washed. Heat setting may be performed using standard industry techniques, such as using a tenter frame apparatus or semi-contact oven. The temperatures used in the heat set process, and duration of heat seating, may be varied depending on the composition and condition of the fabric and the treatment steps applied to the fabric before the fabric is heat set. The processing conditions are typically selected to drive off moisture from the fabric and to set the fabric, but avoid burning or scorching the fabric. In some examples, the heat set temperature is about 20 degrees less than the melting temperature of the materials from which the fabric is constructed. The selection of proper heat set conditions is within the skill of the ordinary art worker. Temperatures and dwell times can be empirically determined.

Representative heat set temperatures are from about 70° C. to about 210° C., such as about 175° C. to about 205° C. In a particular example, the fabric is heat set at about 204° C. (400° F.). The dwell time is typically from about thirty seconds to about two minutes, such as about one minute.

The insecticide may be applied to the fabric at various stages of the manufacturing process, such as before weaving, after weaving, before article formation, and after article formation. In a particular example, the insecticide is added during the finishing stage, after the fabric is woven and heat set, such as before the fabric is formed into finished articles. In more particular examples, the fabric is washed before being impregnated with the insecticide.

In order to aid retention in the fabric, a binder can be added when the insecticide is impregnated in the fabric. In particular examples, the binder is chosen so that the fabric retains an effective amount of insecticide after being washed. For example, the fabric may be constructed to retain insecticidal activity after at least 10 washings, such as at least 25 washings.

Suitable binders are known in the art. Binders include starches, such as amylopectin, polymeric binding agents, such as polyvinyl acetate, and cyclodextrin. U.S. Patent Publication US 2005/0132500, incorporated by reference herein, discloses acrylic binders and other binders that may be used in the methods of the present disclosure. In a particular example, the binder is Appretan, a polyvinyl acetate dispersion available from Clariant, Ltd., of Muttenz, CH.

The insecticide can be applied in any suitable manner, such as by immersing the fabric in a solution of the insecticide or spraying the fabric with an impregnating solution. In particular implementations, the insecticide, and binder, if used, are applied in a jet dye machine. The parameters used in the impregnation process can be empirically determined for a particular fabric and insecticide. In one example, the impregnation process is carried out at about 150° C. at a rate of about 10 meters of fabric per minute.

Other chemicals, such as defoamers, surfactants, and wetting agents, may be added to improve the fabric or aid in the impregnation process. In some examples, the insecticide is applied as a mixture of permethrin, binder, defoamer, and wetting agent. A suitable wetting agent is Sandozin, a polyglycol ether available from Clariant, Ltd. A suitable defoamer is Antimussol N29, a silicon based emulsion available from Clariant, Ltd.

The specific components used in the impregnation process, as well as their respective concentrations, can be varied depending on the particular fabric to be impregnated and the impregnation process used. The amount of insecticide, such as permethrin, added to the impregnation solution is typically enough such that the final fabric will contain the desired amount of insecticide. The precise amount of insecticide to be used for a particular fabric under particular processing conditions can be empirically determined. In some embodiments, such as when the fabric is made of 100% nylon 6,6 fibers, the fabric retains about 20% of permethrin in an impregnating solution.

As a specific example, when the fabric is a 100% nylon 6,6 fabric impregnated with permethrin in a jet dye machine, the impregnation solution can include about 52.5 to about 97.5 g/l permethrin, about 35 to about 65 g/l binder, about 0.7 to about 1.3 g/l defoamer, and about 0.21 to about 0.39 g/l wetting agent. In a particular example, the impregnation solution includes about 75 g/l permethrin, about 50 g/l Appretan N92111, about 1 g/l Antimussol N29, and about 0.3 g/l Sandozin NRW. Although any suitable permethrin source may be used, a particular suitable permethrin source is Sanitized Brand 23-24, available from Sanitized AG, of Burgdof, CH, or Clariant Corp., of Charlotte, N.C.

Fabrics according to the present disclosure can have improved properties compared to prior insecticide impregnated fabrics. For example, the fabrics can be softer, stronger, lighter, and more breathable. The improved tactile properties may make the fabrics more comfortable and thus increase their use.

The fabrics can be used in methods of treating animals, such as horses. For example, the fabrics can be placed on the animal to repel or kill insects, preventing, or reducing the severity of, conditions such as summer eczema or sweet itch. The fabric can be formed into articles, such as fly sheets, useful for such purposes.

### EXAMPLE

### Preparation of a Horse Fly Sheet

Particular fabrics of the present disclosure provide improved fly sheets, such as those useable to repel and kill insects when the fly sheet is placed on a horse. Although the composition of the fly sheet may be varied, it has been discovered that suitable fly sheets may be formed from fabrics having the following properties:

| Weight | 3.8 oz/yd² |
|---|---|
| Width | 80 inches |
| Threads/inch Warp | 6.6 |
| Threads/inch Weft | 16.7 |
| Thickness | 580 μm |
| Open Surface | 16.7% |
| Structure | Plain Weave (L1/1) |
| Elongation Warp | 35% |
| Elongation Weft | 34% |

The present disclosure provides methods of forming such fly sheets. A fabric was weaved having the above described properties, except for the presence of pyrethrin. The fabric was heat set on a tenter frame and then washed. After washing, the fabric was introduced into a jet dye machine and treated at a speed of 10 meters of fabric per minute at 150° C. with a mixture of 75 g/l permethrin, 50 g/l Appretan N92111 (Clariant, Ltd.), 1 g/l Antimussol N29 (Clariant, Ltd.), and 0.3 g/l Sandozin NRW (Clariant, Ltd.). In this example, the maximum reception of the impregnating solution was 30%. The above concentrations are representative and, when a fly sheet is to be the finished product, may be varied by about ±30%.

After being impregnated with permethrin in the jet dye machine, the fabric is dried on a tenter frame apparatus. The fabric can then be formed into finished articles, such as fly sheets.

It is to be understood that the above discussion provides a detailed description of various embodiments. The above descriptions will enable those skilled in the art to make many departures from the particular examples described above to provide apparatuses constructed in accordance with the present disclosure. The embodiments are illustrative, and not intended to limit the scope of the present disclosure. The scope of the present disclosure is rather to be determined by the scope of the claims as issued and equivalents thereto.

What is claimed is:

1. A fabric comprising:
an effective amount of an insecticide; and
prior to impregnation, at least about 80% nylon fibers by fabric weight.

2. The fabric of claim 1, wherein the fabric is formed into a fly sheet.

3. The fabric of claim 1, wherein, prior to impregnation, the fabric comprises 100% nylon fibers by fabric weight.

4. The fabric of claim 1, wherein, prior to impregnation, the fabric comprises 100% nylon 6,6 fibers by fabric weight.

5. The fabric of claim 1, wherein, after impregnation, the fabric comprises at least about 0.30% of an insecticide by weight of impregnated fabric.

6. The fabric of claim 1, wherein, after impregnation, the fabric comprises less than about 3% of an insecticide by weight of impregnated fabric.

7. The fabric of claim 1, wherein the insecticide comprises permethrin.

8. The fabric of claim 1, wherein, after impregnation, the fabric comprises between about 0.38% and about 0.58% permethrin by weight of impregnated fabric.

9. The fabric of claim 1, wherein the insecticide comprises at least one pyrethroid.

10. The fabric of claim 9, wherein the pyrethroid is selected from the group consisting of permethrin, deltamethrin, allethrin, cypermethrin, cyfluthrin, etofenprox, λ-cyhalothrin, and bifenthrin.

11. The fabric of claim 1, wherein, prior to impregnation, the fabric has a weight of between about 3.26 oz/yd² and about 4.41 oz/yd².

12. The fabric of claim 1, wherein, prior to impregnation, the fabric comprises an open surface of between about 14.2% and about 19.2%.

13. The fabric of claim 1, wherein, prior to impregnation, the fabric comprises an open surface of between about 14.2% and about 19.2%, a weight of between about 3.26 oz/yd² and about 4.41 oz/yd², and a thickness of between about 450 μm and about 710 μm.

14. The fabric of claim 13, wherein, after impregnation, the fabric comprises between about 0.52% and 0.58% permethrin by weight of impregnated fabric.

15. The fabric of claim 13, wherein, prior to impregnation, the fabric comprises 100% nylon 6,6 fibers by fabric weight.

16. The fabric of claim 13, wherein the fabric comprises between two and three times as many threads per inch in the weft as the warp.

17. The fabric of claim 13, wherein, prior to impregnation, the warp and weft elongation are between about 25% and about 40%.

18. A method of impregnating a fabric with an insecticide comprising:
impregnating a fabric comprising at least about 80% nylon fibers by weight prior to impregnation with a solution comprising an amount of insecticide sufficient to impregnate the fabric with an effective amount of the insecticide.

19. The method of claim 18, further comprising heat setting the fabric prior to impregnating the fabric.

20. The method of claim 18, wherein the solution comprises a binder.

21. The method of claim 18, wherein the solution comprises an amount of permethrin sufficient to impregnate the fabric with between about 0.30% and 0.58% permethrin by weight of impregnated fabric.

22. A method of preventing or treating summer eczema in an animal having such condition comprising at least partially covering an animal with a fabric comprising at least about 80% nylon fibers by fabric weight prior to impregnation and an effective amount of an insecticide.

23. The method of claim 22 wherein the insecticide comprises between about 0.38% and about 0.58% permethrin by weight of impregnated fabric.

24. The method of claim 22, wherein the nylon fibers are nylon 6,6 fibers.

25. The method of claim 22, wherein the fabric is formed into a fly sheet.
